(19) United States
(12) Patent Application Publication
(10) Pub. No.: US 2016/0214424 A1
(43) Pub. Date: Jul. 28, 2016

(54) Automatic Writing Implement Dispenser

(71) Applicants: Euris Don Lee Ball, Mosheim, TN (US); Kimberly Diane Ball, Mosheim, TN (US)

(72) Inventors: Euris Don Lee Ball, Mosheim, TN (US); Kimberly Diane Ball, Mosheim, TN (US)

(21) Appl. No.: 14/887,905

(22) Filed: Oct. 20, 2015

Related U.S. Application Data
(60) Provisional application No. 62/108,806, filed on Jan. 28, 2015.

(51) Int. Cl. B43K 31/00; G07F 11/24; G07F 7/00; G07F 11/00

(52) U.S. Cl. CPC B43K 31/00; G07F 11/005; G07F 11/24; G07F 7/005

(57) ABSTRACT

A writing implement dispensing device. The device includes an automatic dispensing mechanism for receiving inoperable writing implements and sequentially dispensing operable writing implements. The dispensing device includes a housing having a collection aperture for receiving a writing implement, a first compartment for storing inoperable writing implements, a second compartment for storing operable writing implements, and a dispensing mechanism for dispensing a writing implement. In one embodiment, the dispensing mechanism includes a revolving cylinder configured to rotatably receive and release a plurality of writing implements, an actuator that rotates the cylinder, and a sensor for triggering the actuator in response to an event.

### CROSS REFERENCE TO RELATED APPLICATIONS

This application claims the benefit of U.S. Provisional Application No. 62/108,806 filed on Jan. 28, 2015. The above identified patent application is herein incorporated by reference in its entirety to provide continuity of disclosure.

### FIELD OF THE INVENTION

The present invention relates to dispensers. More specifically, the present invention relates to a writing implement dispenser adapted to sequentially dispense a writing implement.

### BACKGROUND OF THE INVENTION

It is far too often that a student's writing implement becomes inoperative during class. Either the student's pencil becomes unsharpened or the student's pen runs out of ink creating a need for some action by the student. The student may sharpen his pencil using a mechanical or automatic sharpener or the student may cause some sort of commotion in trying to obtain another writing implement from another student. This action by the student can often create loud noises that disrupt class, distract other students, and annoy the teacher in that they interrupt his or her class lesson. However, this action by the student is required because if he or she does not have an operable writing implement handy the student will be unable to take notes or participate, thus hindering his or her learning. Therefore, a device that receives and stores inoperable writing implements and sequentially dispenses operable writing utensils is desired.

Devices are known in the prior are that relate to collecting and dispensing devices. These devices generally relate to dispensers for cutlery utensils or straws, and to devices for sterilizing various objects. However, these devices do not provide a writing implement dispensing device adapted to receive inoperable writing implements and sequentially dispense operable writing implements, which can further be adapted to accept payment from a user.

### SUMMARY OF THE INVENTION

The following summary is provided to indicate the nature of the subject matter disclosed herein. While certain aspects of the present invention are described below, the summary is not intended to limit the scope of the present invention.

In view of the foregoing disadvantages inherent in the known types of dispensers now present in the prior art, the present invention provides an automatic writing implement dispenser wherein the same can be utilized for providing convenience for the user when obtaining an operable writing implement upon his or her writing implement becoming inoperable. The present system comprises a housing which includes a collection aperture configured to receive at least one writing implement, a storage compartment adapted to store a plurality of inserted writing implements, a dispensing compartment adapted to contain a plurality of writing implements to be dispensed, and a dispensing aperture configured to dispense at least one writing implement. The present system further comprises a dispensing mechanism comprising a sensor for sensing the insertion of a writing implement into the housing and an actuator for triggering the release of at least one writing implement from the dispensing compartment, a writing implement receiver for receiving the writing implement once dispensed, and an access door for enabling the user to access the housing to replenish and empty the compartments therein.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of one embodiment of the automatic writing implement dispenser.

FIG. 2 shows a right side view of an embodiment of the automatic writing implement dispenser, wherein the interior compartments are shown.

FIG. 3 shows a front view of the dispensing compartment in one embodiment of the automatic writing implement dispenser.

FIG. 4 shows a perspective view of a second embodiment of the automatic writing implement dispenser.

FIG. 5 shows a schematic view of the electronic components of the automated dispensing mechanism of the writing implement dispenser.

FIG. 6 shows a perspective view of one embodiment of the automatic writing implement dispenser.

### DETAILED DESCRIPTION OF THE INVENTION

Reference is made herein to the attached drawings. Like reference numerals are used throughout the drawings to depict like or similar elements of the automatic writing implement dispenser. For the purposes of presenting a brief and clear description of the present invention, the preferred embodiment will be discussed as used for dispensing pencils. The figures are intended for representative purposes only and should not be considered to be limiting in any respect.

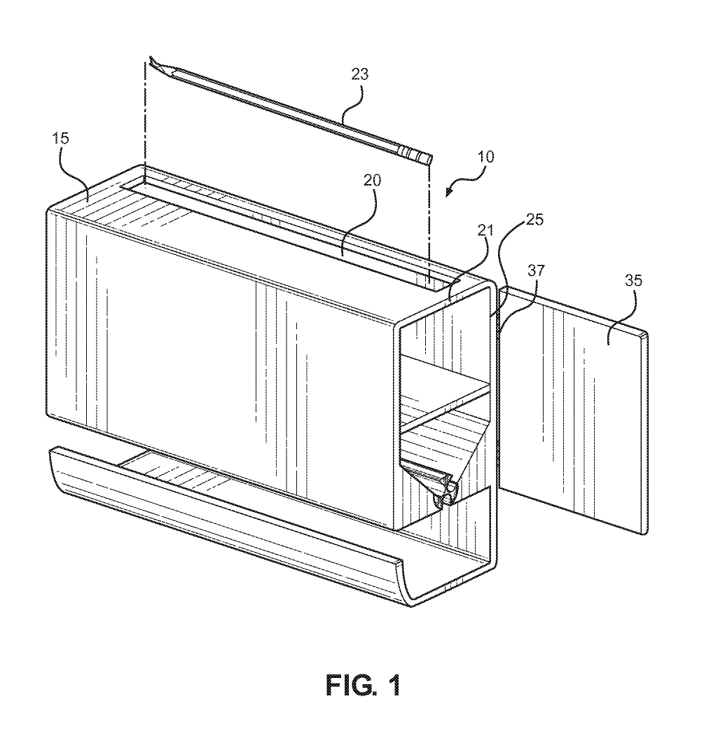

Referring now to FIG. 1, there is shown a view of one embodiment of the writing implement dispensing device of the present invention. The dispensing device 10 comprises a housing 15 having a storage compartment 25 adapted to store one or more writing implements therein. In the illustrated embodiment, the storage compartment 25 comprises a collection aperture 20 on an upper wall 21 thereof so that a user can insert a writing implement through said collection aperture 20 and into the storage compartment 25. The collection aperture 20 is configured to receive a writing implement 23 and can be an elongated rectangular slot or a circular shaped slot adapted to receive either a pencil, pen, or marker or adapted to specifically receive just one type of writing implement.

An access door 35 is disposed on the housing 15 and can be either connected thereto by one or more hinges 37, or removable, for access to the internal components of the housing 15. The access door 35 may be optionally composed of, in whole or in part, from a transparent or translucent material allowing external visual observation of the internal contents, to monitor the need for emptying and replenishing. The access door 35 can optionally include one or more doors, or openings, which can each provide access to a specific internal compartment. As depicted, the writing implement dispensing device 10 is suitable for standalone positioning, as on the table of a classroom. Indicia such as graphics and/or texts may be provided on the access door or elsewhere, to indicate which type of writing implement the writing implement dispensing device is dispensing.

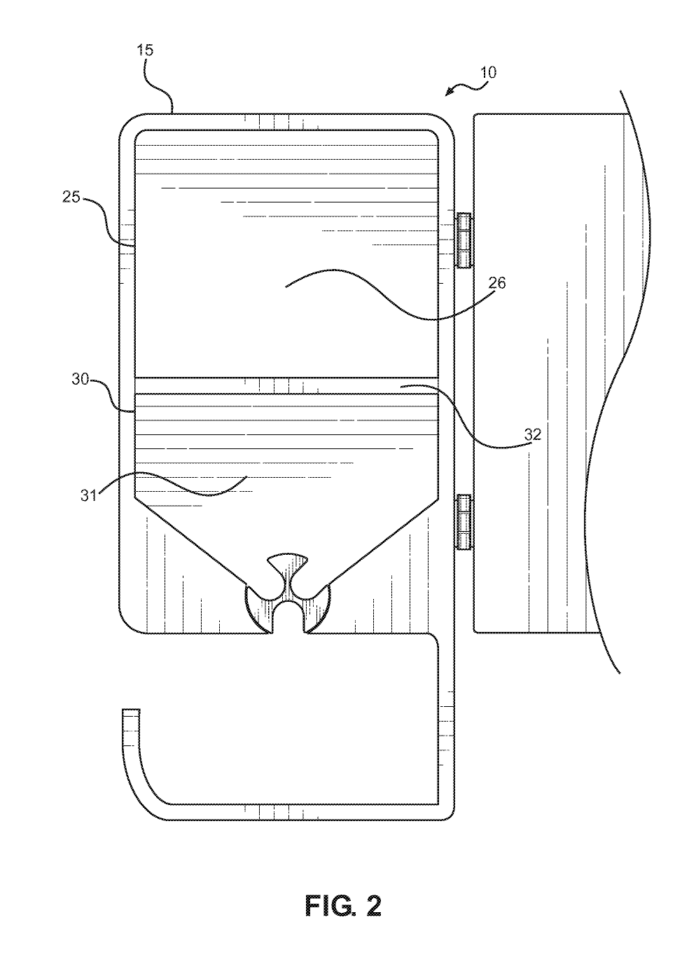

As seen best with reference to FIG. 2, the writing implement dispenser 10 further comprises the storage compartment 25 and the dispensing compartment 30 in the form of regional compartments within the housing 15. The interior profile geometry of the storage compartment 25 and dispensing compartment 30 can be configured for universal use with multiple types of writing implements.

The storage compartment 25 includes a first receiver opening 26 at a side portion thereof, into which writing implements are loaded and replenished. In alternative embodiments, the first receiver opening 26 is positioned for loading writing implements from the side, bottom, or other location into the storage compartment 25. In the depicted embodiment, the storage compartment 25 is loadable with one or more writing implements and has a capacity of at least one writing implement. In alternative embodiments, the storage compartment 25 receives a stack or array of writing implements, or is loaded with an individual writing implement one-by-one or in loose quantity.

The dispensing compartment 30 is adapted for containing a plurality of writing implements to be dispensed. The dispensing compartment 30 includes a second receiver opening 31 at a side portion thereof, into which writing implements are loaded and replenished. In alternative embodiments, the second receiver opening 31 is positioned for loading writing implements from the side, bottom, or other location into the dispensing compartment 30. The dispensing compartment 30 has a capacity of at least one writing implement. In alternative embodiments, the dispensing compartment 30 receives a stack or array of writing implements, or is loaded with an individual writing implement one-by-one or in loose quantity. The dispensing compartment 30 is separated but connected to the storage compartment 25 via a horizontal support member 32.

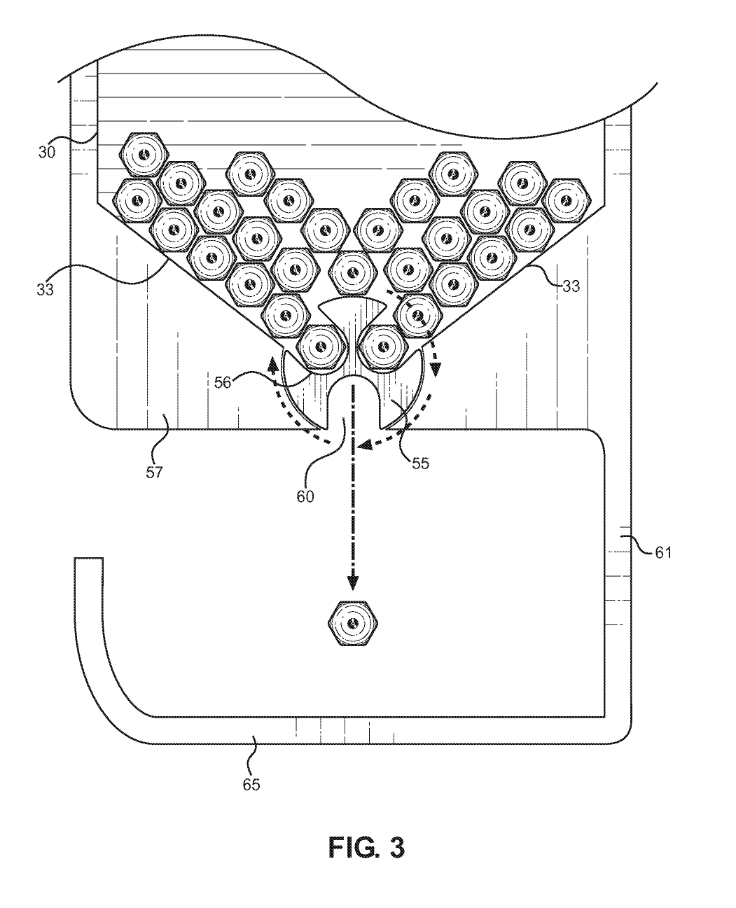

As best seen with reference to FIG. 3, a dispensing mechanism 55 is positioned at a lower end of the dispensing compartment 30. The dispensing mechanism 55 comprises a revolving cylinder disposed in a horizontal orientation. The revolving cylinder comprises a plurality of slots 56 thereon, which are configured to receive at least one writing implement therein. The slots 56 are elongated tubular slots adapted to fit one writing implement. In alternative embodiments, the slots 56 are adapted to fit one or more writing implements. The revolving cylinder comprises plastic or other like suitable material.

A dispensing aperture 60 is connected to the dispensing compartment 30 via a bottom wall 57 thereof so that a writing implement can fall through from the dispensing compartment 30 through the dispensing aperture 60. The dispensing aperture 60 is configured to dispense a writing implement and can be an elongated rectangular slot or a circular shaped slot adapted to dispense either a pencil, pen, or marker or adapted to specifically dispense just one type of writing implement. The size of the collection aperture 60 is greater than or equal to the size of the revolving cylinder's slots 56. A writing implement receiver 65 is connected to the housing via a vertical support member 61. The writing implement receiver 65 is configured to receive and hold a writing implement once dispensed from the dispensing compartment 60 until the user removes it.

In the depicted embodiment, the inside profile geometry of the dispensing compartment 30 is configured in such a way that writing implements loaded therein are forced downward by the force of gravity onto the revolving cylinder. The lower ends 33 of the dispensing compartment 30 taper or slope downward, such that writing implements loaded into the dispensing compartment 30 roll or slide downward along the lower ends 33 towards the dispensing opening via the force of gravity. In alternative embodiments, only one lower end tapers or slopes downward to the dispensing opening.

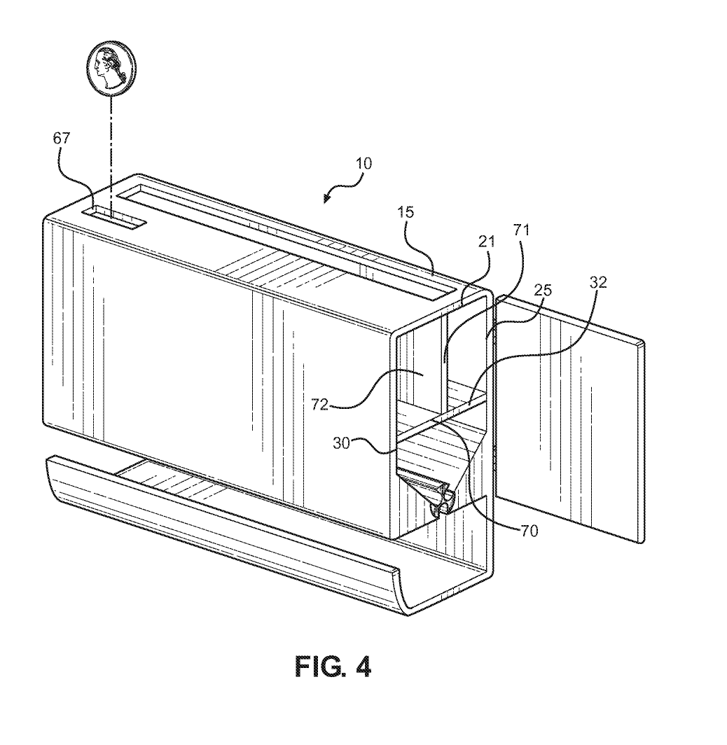

As best seen with reference to FIG. 4, in an alternative embodiment of the present invention, the writing implement dispenser 10 further comprises a second collection aperture 67 and a money compartment 70 disposed in the housing 15. The second collection aperture 67 is connected to the money compartment 70 via the upper wall 21. The money compartment 70 is adapted to store one or more monies therein. In the depicted embodiment, the second collection aperture 67 is configured to receive coins. In alternative embodiments, the collection aperture 67 can be configured to receive dollar bills. The collection aperture 67 can be a circular or rectangular shaped slot. The money compartment 70 is separated but connected to the storage compartment 25 via a vertical support member 71 and to the dispensing compartment 30 via the horizontal support member 32. The money compartment 70 includes a third receiver opening 72 at a side portion thereof, in which the monies can be removed. In alternative embodiments, the third receiver opening 72 is positioned for removing money from the side, bottom, or other location in the money compartment 70.

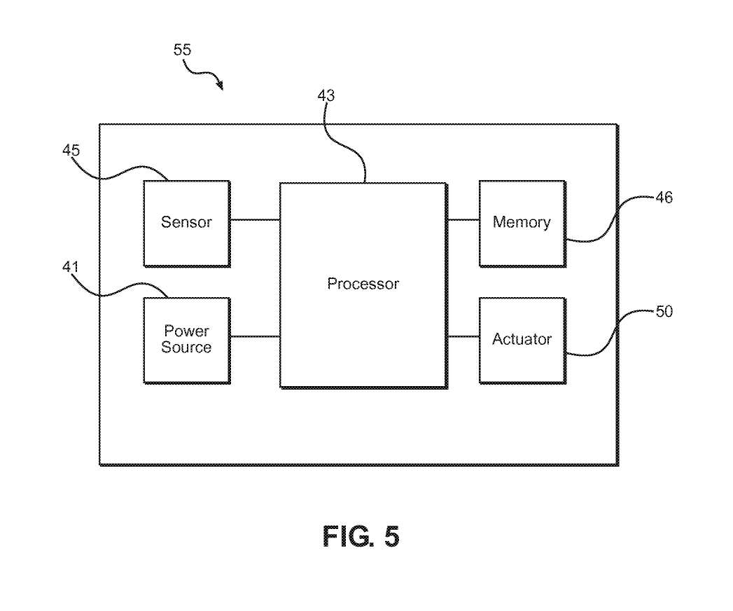

As seen best with reference to FIG. 5, the dispensing mechanism 55 is operated by a power source 41, a processor 43, a sensor 45, a memory 46, and an actuator 50. In one embodiment, the dispensing mechanism 55 is configured for sequentially dispensing a plurality of writing implements from the dispensing compartment via the revolving cylinder. In a second embodiment, the dispensing mechanism 55 is configured to dispense one writing implement at a time. In alternative embodiments, the dispensing mechanism 55 is configured to dispense more than one writing implement at a time.

In some embodiments of the automatic writing implement dispenser, the sensor 45 is a motion or proximity sensor, such as an infrared or ultrasonic motion detector or a capacitive proximity sensor. A variety of commercially available or specially designed sensor devices may be adapted for use in connection with the writing implement dispenser. For example, in alternative embodiments, the sensor can be a touchless, touch-free, a sound or vibration sensor, or other form of sensor or switch for generating a signal in response to an input or event. The sensor 45 is positioned at or near the point of insertion of the writing implement, however, in alternative embodiments the sensor may be disposed in any of various locations on the housing.

The sensor 45 communicates an analog or digital signal by way of a wire, conductor or other electrical, optical, magnetic or electromagnetic communication means, to the processor 43 for controlling the operations of the writing implement dispenser. The processor 43 may be any type of computational device including, for example, a microprocessor, a microcontroller, a programmable logic array, a programmable gate array, an application specific integrated circuit, and the like. The control of the writing implement dispenser may be implemented solely in hardware, or in a combination of hardware, software and/or firmware associated with the processor 43. The processor 43 is typically a microcontroller that performs the control algorithm in software, which may be stored in on-board memory 46 in the microcontroller. The memory 46 may be any type of computer readable medium including, for example, random access memory (RAM), read only memory (ROM), flash memory, compact discs, magnetic tapes, and the like. Signal output from the processor 43 is communicated to the actuator 50 to drive and rotate the revolving cylinder.

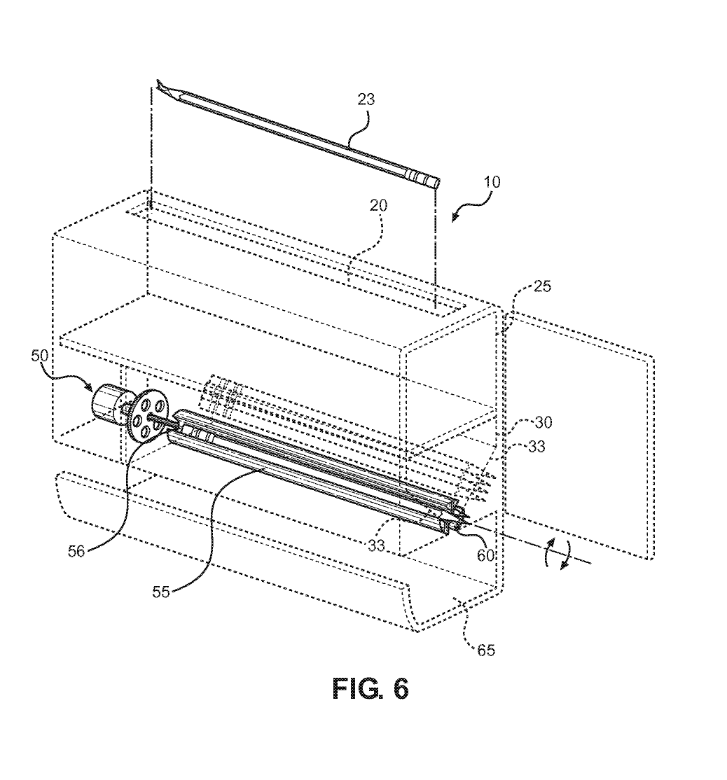

Referring now to FIG. 6, there is shown one embodiment of the writing implement dispenser 10 in use. The sensor senses the insertion of a writing implement 23 into the collection aperture 20 creating a triggering signal to the processor which drives the actuator 50 to rotate the dispensing mechanism 55, such that one of the slots 56 thereon is disposed above the dispensing aperture 60. A writing implement 23 contained in the slot 56 then releases through the dispensing aperture 60 by the force of gravity into the writing implement receiver 65. Upon rotation of the dispensing mechanism 55, a new slot 56 is exposed to the interior of the dispensing compartment 30 and a new writing implement is fed down the lower end 33 into the slot 56 by the force of gravity.

In an alternative embodiment, the sensor senses the insertion of the writing implement into the storage compartment 25, which then sends a triggering signal to the processor, which drives the actuator 50. In other embodiments, the sensor senses the insertion of monies, such as a coin or dollar bill into a money compartment, which sends a triggering signal to the processor which drives the actuator 50. The actuator 50 can comprise a motor or other actuator. In the depicted embodiment, the actuator 50 comprises a motor, a shaft and a flywheel, which is connected to the dispensing mechanism 55 via the shaft and is configured to rotate the cylinder 55. In alternative embodiments, the actuator is disposed inside the revolving cylinder.

In an example method of operation of one embodiment of the writing implement dispensing device 10, a plurality of writing implements are loaded into the dispensing compartment of an automated writing implement dispenser, or an automated writing implement dispenser is provided already loaded with a plurality of disposable writing implements. To load the dispenser, the access door can be opened or removed, and one or more writing implements inserted through a receiver opening into the dispensing compartment. Once loaded, the writing implements fall into the slot or slots of the revolving cylinder. The access door is closed and optionally locked using a key or electronic lock, or a hidden release mechanism is provided to prevent unauthorized access to the interior of the dispenser. If the dispenser's power source is not already connected, it is connected at this time. The dispenser may optionally comprise a power switch and/or manual or electronic lockout to prevent unauthorized access or use, which are activated when ready for use.

When the user needs a writing implement, the dispenser is operated by inserting an inoperable pencil, for example, into the collection aperture. The sensor senses the insertion of the pencil into the storage compartment and communicates a signal to the processor, which in turn outputs one or more control signals to the actuator, which drives the revolving cylinder of the automated dispense mechanism to rotate and release a writing implement from the dispensing compartment into the writing implement receiver. For example, the processor signals the motor to rotate the revolving cylinder through a controlled stroke or motion.

An interlock may be provided to prevent further rotation of the revolving cylinder of the automated dispensing mechanism once a writing implement is dispensed in order to reduce the incidence of waste. Subsequent users will activate the dispenser in a similar manner, and the dispenser sequentially dispenses writing implements one piece at a time from the dispensing compartment.

In alternative embodiments, the writing implement dispenser 10 comprises a different dispensing mechanism configured to dispense one pencil at a time. For example, the writing implement dispenser 10 can comprise a releasable dispenser door attached to the dispensing aperture 60 and configured to open and release at least one writing implement at one time. The sensor senses the insertion of a writing implement into the housing and triggers the actuator to release the dispenser door into an open configuration. A writing implement is released through the dispenser door and the dispensing device 10 thereby dispenses at least one writing implement. Once a writing implement is released, other signal output from the processor is communicated to the actuator to drive a return spring that can be optionally provided to toggle the dispenser door back in to its closed configuration.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A writing implement dispenser, comprising:
a housing having a storage compartment and a dispensing compartment;
wherein a collection aperture is disposed on the housing to provide an entrance into the storage compartment, said dispensing compartment having a dispensing aperture;
wherein said dispensing aperture comprises a dispensing mechanism therein adapted to dispense a writing implement held within the dispensing compartment upon insertion of a writing implement into said storage compartment.

2. The writing implement dispenser of claim 1, wherein the dispensing mechanism further comprises a revolving cylinder having one or more slots in which writing implements can be positioned.

3. The writing implement dispenser of claim 2, wherein actuation of the revolving cylinder is automated.

4. The writing implement dispenser of claim 3, wherein actuation is triggered by a touchless sensor.

5. The writing implement dispenser of claim 4, wherein the touchless sensor comprises a motion sensor.

6. The writing implement dispenser of claim 4, wherein the touchless sensor comprises a proximity sensor.

7. The writing implement dispenser of claim 2, wherein the revolving cylinder is driven by an actuator.

8. The writing implement dispenser of claim 7, wherein the actuator comprises an electric motor.

9. The writing implement dispenser of claim 8, wherein the actuator further comprises a shaft and a flywheel.

10. The writing implement dispenser of claim 7, further comprising a processor for receiving a signal from the sensor and triggering the actuator in response thereto.

11. The writing implement dispenser of claim 1, further comprising a writing implement receiver for receiving a plurality of writing implements once dispensed.

12. The writing implement dispenser of claim 1, further comprising an access door for providing access to the storage compartment and dispensing compartment for emptying and replenishing.

13. The writing implement dispenser of claim 2, wherein the revolving cylinder is configured to receive and dispense writing implements via the force of gravity.

14. A writing implement dispenser of claim 1, wherein the housing further comprises a money compartment having a collection aperture adapted to receive money.

15. The writing implement dispenser of claim 14, wherein the dispensing mechanism is adapted to dispense a writing implement held within the dispensing compartment upon insertion of money into the collection aperture of the money compartment.

16. The writing implement dispenser of claim 15, wherein actuation of the dispensing mechanism is automated.

17. The writing implement dispenser of claim 16, wherein actuation is triggered by a touchless sensor.

18. The writing implement dispenser of claim 17, wherein the touchless sensor comprises a motion sensor.

19. The writing implement dispenser of claim 17, wherein the touchless sensor comprises a proximity sensor.
